(19) United States
(12) Patent Application Publication
(10) Pub. No.: US 2015/0024240 A1
(43) Pub. Date: Jan. 22, 2015

(54) EXCHANGEABLE ENERGY STORAGE DEVICE

(71) Applicant: Robert Bosch GmbH, Stuttgart (DE)

(72) Inventors: Bernhard Seubert, Korntal-Muenchingen (DE); Peter Feuerstack, Ludwigsburg (DE); Steffen Berns, Bangalore (IN)

(21) Appl. No.: 14/380,730

(22) PCT Filed: Jan. 2, 2013
(86) PCT No.: PCT/EP2013/050019

§ 371 Date: Aug. 25, 2014

(30) Foreign Application Priority Data
Feb. 24, 2012 (DE) 10 2012 202 860.9

(51) Int. Cl. H01M 10/42

(52) U.S. Cl. CPC H01M 10/4207; H01M 10/425; H01M 2010/4271; H01M 2220/20
USPC 429/50; 429/158

(57) ABSTRACT

The invention relates to an energy storage device (1) having storage modules (3) which are connected in series in a supply section and which in each case comprises an energy storage cell module (5) having at least one energy storage cell (5a, 5k) and a coupling device (7) having coupling elements (7a, 7b, 7c, 7d) which are designed selectively to switch the energy storage cell module (5) into the supply section or to bridge said energy storage cell module. The energy storage cells or the energy storage cell modules can be exchanged.

### BACKGROUND OF THE INVENTION

The invention relates to an exchangeable energy storage device and a method for exchanging an energy storage device, in particular an energy storage device having a modular battery system for an electrically operated vehicle.

It is becoming apparent that in the future both in the case of stationary applications, such as for example wind turbines or solar panels, and also in vehicles, such as hybrid or electric vehicles, greater use will be made of electronic systems that combine new energy storage technologies with electrical drive technology.

The supply of multiphase current into an electrical machine is generally provided by means of an inverter in the form of a pulse width modulated inverter. For this purpose, a direct current voltage that is provided by a direct current voltage intermediate circuit can be converted into a multiphase alternating current voltage, by way of example a three-phase alternating current voltage. The direct current voltage intermediate circuit is supplied by a string of series-connected battery modules. Multiple battery modules are frequently connected in series in a traction battery in order to be able to fulfill the relevant requirements relating to performance and energy for a particular application.

The publications DE 10 2010 027 857 A1 and DE 10 2010 027 861 A1 disclose modular connected battery cells in energy storage devices, wherein said battery cells can be selectively coupled or uncoupled into the string of series-connected battery cells by virtue of suitably controlling coupling units. Systems of this type are known by the name battery direct converter (BDC). Systems of this type comprise direct current sources in an energy storage module string that can be connected to a direct current voltage intermediate circuit for the purpose of supplying electrical energy to an electrical machine or an electrical network by way of a pulse width modulated inverter.

The energy storage module string comprises a plurality of series-connected energy storage modules, wherein each energy storage module comprises at least one battery cell and an allocated controllable coupling unit that renders it possible in dependence upon control signals to bridge the respective allocated at least one battery cell or to connect the respective allocated at least one battery cell into the respective energy storage module string. Optionally, the coupling unit can be designed so as to render it possible in addition to connect the respective allocated at least one battery cell also having reverse polarity into the respective energy storage module string, or also to disconnect the respective energy storage module string.

BDCs generally comprise a higher efficiency level and are more reliable with respect to conventional systems. The reliability is ensured, inter alia, by virtue of the fact that defective battery cells that have failed or are not fully functional can be disconnected from the energy supply string by virtue of suitably controlling the bridging of the coupling units. The total output voltage of the energy storage module string can be adjusted in a varied and in particular stepped manner by virtue of correspondingly controlling the coupling units. The stepped adjustment of the output voltage is determined from the voltage of an individual energy storage module, wherein the maximum possible total output voltage is determined by the total of the voltages of all energy storage modules of the energy storage module string.

Coupling units can be controlled in a pulse width modulated manner (PWM) in order to adjust an output voltage of an energy storage module. As a consequence, it is possible to provide a desired mean value as an energy storage module voltage by varying the switch-on and/or switch-off times in a purposeful manner.

The energy storage cells that are installed in the energy storage modules are subject to deterioration in power, charging capacity and/or output voltage as a result of aging and wear so that it is necessary to replace the energy storage cells after a certain operating period. In particular in the case of electrically operated vehicles, this replacement can represent a considerable cost factor.

The publication US 2011/0064981 A1 discloses a modular battery system, for example for an electric car and in said battery system, individual battery cells of a specifically arranged coupling system can be exchanged when required.

However, BDCs require exchangeable components that can be adapted to suit the existing entire system in a problem free and flexible manner after the end of the serviceable life of an existing BDC.

### SUMMARY OF THE INVENTION

The present invention provides in accordance with one aspect an energy storage device having a multiplicity of energy storage modules that are series-connected in an energy supply string, said energy storage device comprising in each case an energy storage cell module that comprises at least one energy storage cell and a coupling device having coupling elements that are designed so as to selectively connect the energy storage cell module into the respective energy supply string or bridge said energy storage cell module. The energy storage cells and/or the energy storage cell modules are configured in such a manner that they can be exchanged.

In accordance with a further aspect, the present invention provides a system component having an energy storage device in accordance with the invention and having a coupling inductance that is coupled to an output connector of the energy storage device.

In accordance with a further aspect, the present invention provides a system having an exchangeable system component in accordance with the invention, a direct current voltage intermediate circuit that is coupled to the energy storage device of the exchangeable system component, a pulse width modulated inverter that is coupled to the direct current voltage intermediate circuit and that is supplied with an input voltage by the direct current voltage intermediate circuit, said system having an electrical machine that is coupled to the pulse width modulated inverter and that is supplied with a phase voltage by the pulse width modulated inverter, and said system having a control device that is coupled to the coupling devices, and that is designed so as to selectively control the coupling devices of the energy storage device for the purpose of providing a total output voltage of the energy storage device.

In accordance with a further aspect, the present invention provides a method for exchanging an energy storage device of an electrical system, said method comprising the steps of decoupling a first energy storage device from a direct current voltage intermediate circuit of the system, said energy storage device having a multiplicity of energy storage modules that are series-connected in an energy supply string and comprise in each case an energy storage cell module that comprises at least one energy storage cell and a coupling device having coupling elements that are designed so as to selectively connect the energy storage cell module into the energy supply string or bridge said energy storage cell module, said method also comprising the step of connecting a second energy storage device to the direct current voltage intermediate circuit of the system, said second energy storage device having a multiplicity of energy storage modules that are series-connected in an energy supply string and comprise in each case an energy storage cell module that comprises at least one energy storage cell and a coupling device having coupling elements that are designed so as to selectively connect the energy storage cell module into the energy supply string or to bridge said energy storage cell module and said method also comprising the step of controlling the coupling elements of the coupling devices of the second energy storage device in dependence upon the operating parameters of the energy storage cell modules and/or the energy storage cells of the second energy storage device.

The object of the present invention is to provide as an exchangeable component an energy storage device that is constructed in a modular manner and comprises battery cells that are series-connected in one or multiple strings and which can be adapted in a flexible manner to suit the behavior of the energy storage device that is to be exchanged. For this purpose, the energy storage device comprises individual energy storage cell modules having multiple energy storage cells that can be selectively connected into the strings by way of a control device that is connected to the energy storage device or integrated into the energy storage device. The control device can compare the operating parameters of the energy storage cells that are built into the energy storage device with the relevant technical data for the entire system and emulate a corresponding operating behavior in the exchangeable energy storage device by virtue of suitably controlling the coupling devices of the energy storage modules.

This has the advantage that it is only necessary to provide as a replacement one construction type of exchangeable energy storage devices and said construction type can be configured in a flexible manner for different applications. A further advantage is that with the exchangeable energy storage device the respective current energy storage device technology can be used without the danger that the current energy storage cells could be incompatible with the older exchange system.

In addition, it is advantageously possible to produce energy storage cells promptly as and when they are required. Since energy storage cells also age “with respect to lapsed time since being placed in store”, in other words they suffer a loss of storage capacity with the passage of time even when not in use, it is not necessary with the energy storage device in accordance with the invention to produce and place in store energy storage cells that are compatible with the energy storage device. In lieu of this, energy storage cells that are produced as new promptly as and when required can be adapted to suit the exchangeable system in each case in a flexible manner.

In accordance with one embodiment of the energy storage device in accordance with the invention, the coupling devices can be designed so as to bridge the energy storage cell modules of all the energy storage modules in the energy supply string if the energy storage device is not in operation.

In accordance with a further embodiment of the energy storage device in accordance with the invention, the coupling devices can be designed so as to bridge the energy storage cell modules of all the energy storage modules in the energy supply string if the energy storage device is not in operation.

In accordance with a further embodiment of the energy storage device in accordance with the invention, the coupling devices can comprise power MOSFET switches or IGBT switches.

In accordance with one embodiment of the method in accordance with the invention, the method can further comprise the steps of determining the operating parameters of the energy storage cell modules and/or the energy storage cells of the first energy storage device, and said method can further comprise the step of emulating the determined operating parameters by means of correspondingly controlling the coupling elements of the coupling devices of the second energy storage device in dependence upon the operating parameters of the energy storage cell modules and/or the energy storage cells of the second energy storage device.

Further features and advantages of embodiments of the invention are evident in the description hereinunder with relation to the attached drawings.

### BRIEF DESCRIPTION OF THE DRAWINGS

In the drawings:

FIG. 1 illustrates a schematic illustration of a system having an exchangeable energy storage device in accordance with one embodiment of the present invention;

FIG. 2 illustrates a schematic illustration of an exemplary embodiment of an energy storage module of an energy storage device according to FIG. 1;

FIG. 3 illustrates a schematic illustration of a further exemplary embodiment of an energy storage module of an energy storage device according to FIG. 1; and

FIG. 4 illustrates a schematic illustration of a method for exchanging an energy storage device in a system in accordance with a further embodiment of the present invention.

### DETAILED DESCRIPTION

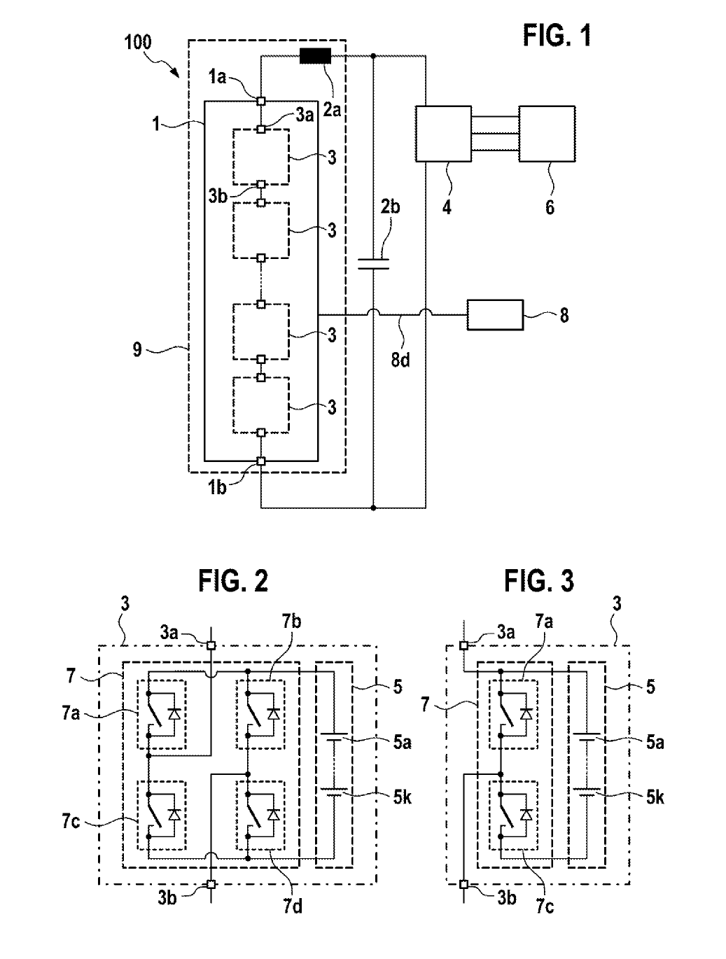

FIG. 1 illustrates a system 100 for converting voltage from direct current voltage that is provided by means of an energy storage module 3 into an n-phase alternating current voltage. The system 100 comprises an energy storage device 1 having energy storage modules 3 that are connected in series in an energy supply string. The energy supply string is coupled between two output connectors la and lb of the energy storage device 1 that are coupled in each case to a direct current voltage intermediate circuit 2b. In an exemplary manner, the system 100 is used in FIG. 1 for supplying energy to a three phase electrical machine 6. However, it can also be provided that the energy storage device 1 is used for generating electrical current for an energy supply network 6.

The energy storage device 1 is coupled for this purpose to the direct current voltage intermediate circuit 2b by way of a coupling inductance 2a. The coupling inductance 2a can by way of example be an inductor that is connected in a purposeful manner between the direct current voltage intermediate circuit 2b and the output connector 1a of the energy storage device 1. Alternatively, it is also possible that the coupling inductance 2a is formed by means of parasitic inductances that are already provided in the circuitry between the energy storage device 1 and the direct current voltage intermediate circuit 2b.

The direct current voltage intermediate circuit 2b supplies energy to a pulse width modulated inverter 4 that provides a three phase alternating current voltage for the electrical machine 6 from the direct current voltage of the direct current voltage intermediate circuit 2b.

The system 100 can furthermore comprise a control device 8 that is connected to the energy storage device 1 and with the aid of which the energy storage device 1 can be controlled in order to provide the desired total output voltage of the energy storage device 1 at the respective output connectors 1a, 1b. Furthermore, the control device 8 can be designed so as to control the respective coupling elements and/or active switching elements of the energy storage device 1 whilst charging the energy storage cells of the energy storage device 1.

The energy supply string of the energy storage device 1 comprises at least two series-connected energy storage modules 3. In an exemplary manner, the number of energy supply modules 3 in FIG. 1 amounts to four, wherein however any other number of energy storage modules 3 is likewise possible. The energy storage modules 3 comprise in each case two output connectors 3a and 3b by way of which a module output voltage of the energy storage modules 3 can be provided. Since the energy storage modules 3 are primarily connected in series, the sum of the module output voltages of the energy storage modules 3 amounts to the total output voltage that is provided at the output connectors 1a, 1b of the energy storage device 1.

Two exemplary constructions of the energy storage modules 3 are illustrated in FIG. 2 and FIG. 3 in greater detail. The energy storage modules 3 comprise in each case a coupling device 7 having multiple coupling elements 7a, 7c and also 7b and 7d. Furthermore, the energy storage modules 3 comprise in each case an energy storage cell module 5 having one or multiple series-connected energy storage cells 5a to 5k.

The energy storage cell module 5 can comprise by way of example series-connected cells 5a to 5k by way of example lithium ion cells. The number of energy storage cells 5a to 5k in the energy storage modules 3 that are illustrated in FIG. 2 and FIG. 3 amounts to two in an exemplary manner, wherein however any other number of energy storage cells 5a to 5k are likewise possible. The energy storage cell modules 5 comprise a terminal voltage of UM and are connected to input connectors of the associated coupling device 7 by way of connecting lines. The voltage U_{M} therefore prevails at the input terminals of the associated coupling device 7.

In FIG. 2, the series-connected coupling elements 7a and 7c whose middle tap is connected to the output terminals 3a form the so called left-hand branch of the full bridge circuit and the series-connected coupling elements 7b and 7d whose middle tap is connected to the output terminal 3b form the so called right-hand branch of the full bridge. The coupling device 7 is embodied in FIG. 2 as a full bridge circuit having respectively two coupling elements 7a, 7c and two coupling elements 7b, 7d. The coupling elements 7a, 7b, 7c, 7d can in each case comprise an active switching element, by way of example a semiconductor switch, and a free-wheeling diode that is connected parallel thereto. It can be provided that the coupling elements 7a, 7b, 7c, 7d are embodied as MOSFET switches that already comprise an intrinsic diode.

The coupling elements 7a, 7b, 7c, 7d can be controlled, by way of example with the aid of the control device 9 that is illustrated in FIG. 1, in such a manner that the respective energy storage cell module 5 is selectively connected between the output connectors 3a and 3b or that the energy storage cell module 5 is bridged. In relation to FIG. 2, the energy storage cell module 5 can be connected by way of example in forward polarity between the output connectors 3a and 3b, in that the active switching element of the coupling element 7d and the active switching element of the coupling element 7a are set into a closed state while the two remaining active switching elements of the coupling elements 7b and 7c are set into an open state. In this case, the voltage U_{M} prevails between the output terminals 3a and 3b of the coupling device 7. A bridging state can be achieved by way of example by virtue of the fact that the two active switching elements of the coupling elements 7a and 7b are set into the closed state while the two active switching elements of the coupling elements 7c and 7d are held in the open state. A second bridging state can be achieved by way of example by virtue of the fact that the two active switches of the coupling elements 7c and 7d are set into the closed state while the active switching elements of the coupling elements 7a and 7b are held in the open state. In the two bridging states, the voltage 0 prevails between the two output terminals 3a and 3b of the coupling device 7. Likewise, the energy storage cell module 5 can be connected in reverse polarity between the output connectors 3a and 3b of the coupling device 7, in that the active switching elements of the coupling elements 7b and 7c are set into the closed state while the active switching elements of the coupling elements 7a and 7d are set into the open state. In this case, the voltage—U_{M} prevails between the two output terminals 3a and 3b of the coupling device 7.

Individual energy storage cell modules 5 of the energy storage modules 3 can then be integrated in a purposeful manner in the series circuitry of the energy supply string by virtue of suitably controlling the coupling devices 7. As a consequence, it is possible to provide a total output voltage by virtue of purposefully controlling the coupling devices 7 for the purpose of selectively connecting the energy storage cell modules 5 of the energy storage module 3 into the energy supply branch and said total output voltage is dependent upon the individual output voltages of the energy storage cell modules 5 of the energy storage modules 3. The total output voltage can in each case be adjusted in a stepped manner, wherein the number of steps is scaled to suit the number of energy storage modules 3. In the case of a number of n energy storage modules 3, the total output voltage of the energy supply string can be adjusted in 2n+1 steps between −n.U_{M}, . . . ,0, . . . , +n.U_{M}.

FIG. 3 illustrates a schematic illustration of a further exemplary embodiment for an energy storage module 3. The coupling device 7 comprises only the coupling elements 7a and 7c that as a half bridge circuit can connect the energy storage cell module 5 into a bridging state or a connecting state in forwards polarity into the energy supply string. Incidentally, from that similar control principles apply as is explained in relation to FIG. 3 for the illustrated energy storage module 3 in full bridge circuit.

The energy storage device 1 in FIG. 1 is configured as an exchangeable system component 9. The exchangeable system component 9 can also comprise by way of example the coupling inductance 2a. If the hitherto (old) energy storage device 1 can no longer fulfill its functionality as a result of ageing, malfunction and/or operational dependent effects, by way of example because the storage capacity no longer suffices, a replacement energy storage device can be installed in the system 100 as a new energy storage device 1. For this purpose, the system component 9 is entirely replaced and the system component 9 having the new energy storage device 1 is connected to the direct current voltage intermediate circuit 2b and also the control device 8 by way of the control line 8d.

Alternatively, it can also be possible that the system component 9 comprises the control device 8 as the control device 8 that is integrated in the system component 9. It is equally also possible that the coupling inductance 2a is not a part of the system component 9, rather it represents a component that is integrated into the system 100.

In the energy storage device 1, the energy storage cell module 5 or alternatively the energy storage cells 5a to 5k can themselves be exchangeable, in other words the energy storage device 1 comprises only the energy storage module 3 having the coupling devices 7, and the energy storage cell modules 5 and accordingly the energy storage cells 5a to 5k can be installed or built in to the energy storage modules 3 as required when using the energy storage device 1. In other words, it is not necessary to produce and place in store the energy storage cell modules 5 and accordingly the energy storage cells 5a to 5k. As a consequence, it is always possible to use current storage cell technology. Furthermore, it is possible to produce the energy storage cells 5a to 5k at the point in time at which they are actually required in order to reduce the influences of ageing with respect to lapsed time since being placed in store.

It is possible to provide at least as many energy storage modules 3 for the energy storage device 1 so that for all possible applications the minimum voltage of the exchangeable energy storage unit 1 can still be achieved by means of using all energy storage modules 3. In the case of the required total output voltage of the energy storage device 1 of the exchange system being lower than the maximum possible output voltage of the energy storage device 1, it is possible to select from among the energy storage modules 3 that are to be connected in order to adjust the total output voltage of the energy storage device 1 to suit the exchange system. In order to distribute the load on the energy storage modules 3 in a uniform manner, it is possible to alternate periodically the energy storage modules 3 that are to be connected.

The control device 8 can determine the type and the technical parameters of the installed energy storage cell modules 5 and accordingly of the energy storage cells 5a to 5k in the energy storage device 1 in order to establish the corresponding control strategy of the respective coupling devices 7. If, by way of example, a total output voltage of the energy storage device 1 is necessary and said total output voltage cannot be represented with the stepped arrangement of the individual output voltages of the energy storage modules 3, the control device 3 can control in a pulse width modulated (PWM) operation one or multiple of the energy storage modules 3 so that the desired total output voltage of the energy storage device 1 can be provided by way of periodically selecting and deselecting individual energy storage modules 3 to produce a mean value over time. The coupling inductance 2a can help to reduce or rather to eliminate the current fluctuations between the energy storage device 1 and the direct current voltage intermediate circuit.

In order to charge the energy storage device 1 and accordingly the energy storage cells 5a to 5k, it is possible for the control device 8 to reduce the voltage of the energy storage device 1 in such a manner that the maximum voltage of the exchanged battery of the exchange system is not exceeded. The energy storage modules 3 can be charged in a uniform manner by means of a periodic alternating method to produce a mean value over time.

If the system component 9 having the energy storage cells 5a to 5k is placed in store, in other words is not built into a system 100, the coupling devices 7 can be adjusted in such a manner that the energy storage cells 5a to 5k can always be bridged in the energy supply string. As a consequence, the total output voltage of the energy storage device 1 and accordingly the system component 9 that is available towards the exterior is zero. The greatest magnitude of voltage that is present internally in the energy storage device 1 is the output voltage of an individual energy storage module 3. As a consequence, the danger posed to the user as a result of electric shocks whilst handling the system components 9 is reduced.

If one of the energy storage modules 3 is defective or destroyed, the control device 8 can no longer consider this energy storage module 3 when selecting the energy storage module 3 that is to be connected during operation. The reliability of the entire system component 9 is therefore improved since even in the case of a defective individual energy storage module 3, the entire energy storage device 1 remains useable.

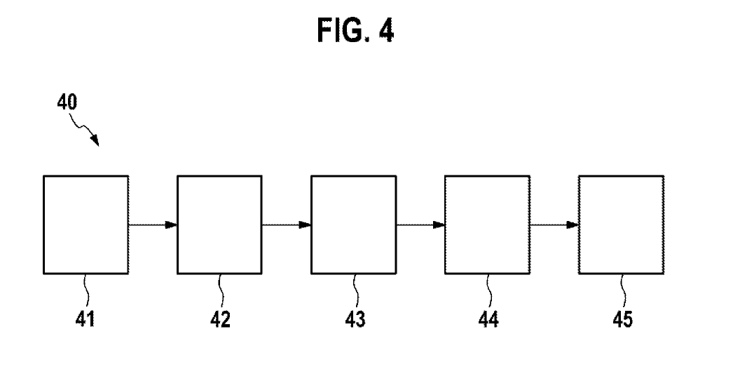

FIG. 4 illustrates a schematic illustration of a method 40 for exchanging an energy storage device, by way of example the energy storage device 1 in FIG. 1. The method 40 can comprise as a first step 41 a process of decoupling a first energy storage device from a direct current voltage intermediate circuit of the system. The first energy storage device can be an energy storage device 1, as is illustrated in FIG. 1. Subsequently, it is possible in a step 42 to connect a second energy storage device to the direct current voltage intermediate circuit of the system. The second energy storage device can be constructed topologically in almost the same manner as the first energy storage device.

It is possible in a step 43 to control the coupling elements of the coupling devices of the second energy storage device in dependence upon the operating parameters of the energy storage cell modules and/or the energy storage cells of the second energy storage device. The respective technology of the installed energy storage cell modules and accordingly energy storage cells can be taken into consideration.

Optionally, it is possible in a step 44 to determine the operating parameters of the energy storage cell modules and/or the energy storage cells of the first energy storage device. These operating parameters can be emulated in an optional step 45 by virtue of correspondingly controlling the coupling elements of the coupling devices of the second energy storage device, in that the operating parameters of the energy storage cell modules and/or the energy storage cells of the second energy storage device are taken into consideration. As a consequence, the replacement energy storage device can be tailored to suit the exchange system even if the type and the technical design of the new energy storage cell modules and accordingly energy storage cells do not correspond with the energy storage cell modules and accordingly energy storage cells that are to be changed.

The method 40 is suitable for providing replacement energy storage devices for different applications in which battery cells are used for the purpose of providing electrical energy for an electrical load. By way of example, the method 40 for replacing energy storage devices can be used in electrical drive systems of electrically operated vehicles.

1. An energy storage device (1) having:
a multiplicity of energy storage modules (3) that are series-connected in an energy supply string and comprise in each case:
an energy storage cell module (5) that comprises at least one energy storage cell (5a, 5k), and
a coupling device (7) having coupling elements (7a, 7b; 7c, 7d) that are configured to selectively connect the energy storage cell module (5) in to the energy supply string or bridge said energy storage cell module (5),
wherein at least one of the energy storage cells (5a, 5k) and the energy storage cell modules (5) are configured in such a manner that they can be exchanged.

2. The energy storage device (1) as claimed in claim 1, wherein the coupling devices (7) comprise power MOSFET switches or IGBT switches.

3. The energy storage device (1) as claimed in claim 1, wherein the coupling devices (7) are configured to bridge the energy storage cell modules (5) of all the energy storage modules (3) in the energy supply string if the energy storage device (1) is not in operation.

4. A system component (9) having:
an energy storage device (1) as claimed in claim 1, and
a coupling inductance (2a) that is coupled to an output connector (1a) of the energy storage device (1).

5. A system (100) having:
a system component (9) as claimed in claim 4,
a direct current voltage intermediate circuit (2b) that is coupled to the energy storage device (1) of the exchangeable system component (9),
a pulse width modulated inverter (4) that is coupled to the direct current voltage intermediate circuit (2b) and is supplied with an input voltage from the direct current voltage intermediate circuit (2b),
an electrical machine (6) that is coupled to the pulse width modulated inverter (4) and is supplied with a phase voltage by the pulse width modulated inverter (4), and
a control device (8) that is coupled to the coupling devices (7) and is configured to selectively control the coupling devices (7) of the energy storage device (1) for the purpose of providing a total output voltage of the energy storage device (1).

6. A method (40) for exchanging an energy storage device (1) of an electrical system (100), comprising the steps of:
decoupling (41) a first energy storage device (1) from a direct current voltage intermediate circuit (2b) of the system (100), said first energy storage device having a multiplicity of energy storage modules (3) that are series-connected in an energy supply string and comprise in each case:
an energy storage cell module (5) that comprises at least one energy storage cell (5a, 5k), and
a coupling device (7) having coupling elements (7a, 7b; 7c, 7d) that are configured to selectively connect the energy storage cell module (5) into the energy supply string or bridge said energy storage cell module,
connecting (42) a second energy storage device (1) to the direct current intermediate circuit (2b) of the system (100), said second energy storage device (1) having a multiplicity of energy storage modules (3) that are series-connected in an energy supply string and comprise in each case:
an energy storage cell module (5) that comprises at least one energy storage cell (5a, 5k), and
a coupling device (7) having coupling elements (7a, 7b; 7c, 7d) that are configured to selectively connect the energy storage cell module (5) of the second energy storage device into the energy supply string or bridge said energy storage cell module of the second energy storage device,
controlling (43) the coupling elements (7a, 7b; 7c, 7d) of the coupling devices (7) of the second energy storage device (1) in dependence upon the operating parameters of at least one of the energy storage cell modules (5) and the energy storage cells (5a, 5k) of the second energy storage device (1).

7. The method (40) as claimed in claim 6, furthermore comprising the steps of:
determining (44) operating parameters of at least one of the energy storage cell modules (5) and the energy storage cells (5a, 5k) of the first energy storage device (1), and
emulating (45) determined operating parameters by virtue of correspondingly controlling the coupling elements (7a, 7b; 7c, 7d) of the coupling devices (7) of the second energy storage device (1) in dependence upon the operating parameters of at least one of the energy storage cell modules (5) and the energy storage cells (5a, 5k) of the second energy storage device (1).

8. The energy storage device (1) as claimed in claim 2, wherein the coupling devices (7) are configured to bridge the energy storage cell modules (5) of all the energy storage modules (3) in the energy supply string if the energy storage device (1) is not in operation.

9. A system component (9) having:
an energy storage device (1) as claimed in claim 8, and
a coupling inductance (2a) that is coupled to an output connector (1a) of the energy storage device (1).

10. A system (100) having:
a system component (9) as claimed in claim 9,
a direct current voltage intermediate circuit (2b) that is coupled to the energy storage device (1) of the system component (9),
a pulse width modulated inverter (4) that is coupled to the direct current voltage intermediate circuit (2b) and is supplied with an input voltage from the direct current voltage intermediate circuit (2b),
an electrical machine (6) that is coupled to the pulse width modulated inverter (4) and is supplied with a phase voltage by the pulse width modulated inverter (4), and
a control device (8) that is coupled to the coupling devices (7) and is configured to selectively control the coupling devices (7) of the energy storage device (1) for the purpose of providing a total output voltage of the energy storage device (1).
